(19) United States
(12) Patent Application Publication
(10) Pub. No.: US 2017/0052072 A1
(43) Pub. Date: Feb. 23, 2017

(54) METHOD FOR DIAGNOSING A FAULT IN A CABIN TEMPERATURE CONTROL SYSTEM OF AN AIRCRAFT

(71) Applicant: Taleris Global LLP, Gloucestershire (GB)

(72) Inventors: Frank BEAVEN, Southampton (GB); Robert William HORABIN, Southampton (GB); Julia Ann HOWARD, Fareham (GB)

(21) Appl. No.: 15/120,019

(22) PCT Filed: Feb. 21, 2014
(86) PCT No.: PCT/GB2014/050510

§ 371 Date: Aug. 18, 2016

(51) Int. Cl. G01K 15/00; G05B 23/02; B64D 13/06

(52) U.S. Cl. CPC G01K 15/007; B64D 13/06; G05B 23/0267; B64D 2013/0655; G01K 2201/02

(57) ABSTRACT

A method of diagnosing a fault in a cabin temperature control system of an air-conditioning system of an aircraft includes transmitting multiple temperature sensor readings from temperature sensors operably coupled to the air-conditioning system, comparing the transmitted multiple temperature sensor readings to related reference values, and diagnosing a fault in the cabin temperature control system based on the comparing.

### BACKGROUND

Contemporary aircrafts have air-conditioning systems that take hot air from the engines of the aircraft for use within the aircraft including for use in a cabin of the aircraft. A cabin temperature control system may be utilized for controlling temperatures within the cabin. Currently, airlines and maintenance personnel wait until a fault or problem occurs with the cabin temperature control system and then attempt to identify the cause and fix it during either scheduled or, more likely, unscheduled maintenance. Fault occurrences are also recorded manually based on pilot discretion.

### BRIEF DESCRIPTION

Embodiments generally relate to a method of diagnosing a fault in a cabin temperature control system including transmitting multiple temperature sensor readings from temperature sensors operably coupled to the air-conditioning system, comparing the transmitted multiple temperature sensor readings to related reference values, diagnosing, by a controller, a fault in the cabin temperature control system based on the comparing, and providing an indication of the diagnosed fault.

### BRIEF DESCRIPTION OF THE DRAWINGS

In the drawings:

FIG. 1 illustrates an example of an aircraft and a ground system in accordance with various aspects descried herein;

FIG. 2 illustrates an example schematic view of a portion of an air-conditioning system in accordance with various aspects described herein;

FIG. 3 illustrates an example schematic view of a portion of an air-conditioning system in accordance with various aspects described herein; and

FIG. 4 is an example flowchart showing a method of diagnosing a cabin temperature control system fault in an aircraft in accordance with various aspects described herein.

### DETAILED DESCRIPTION

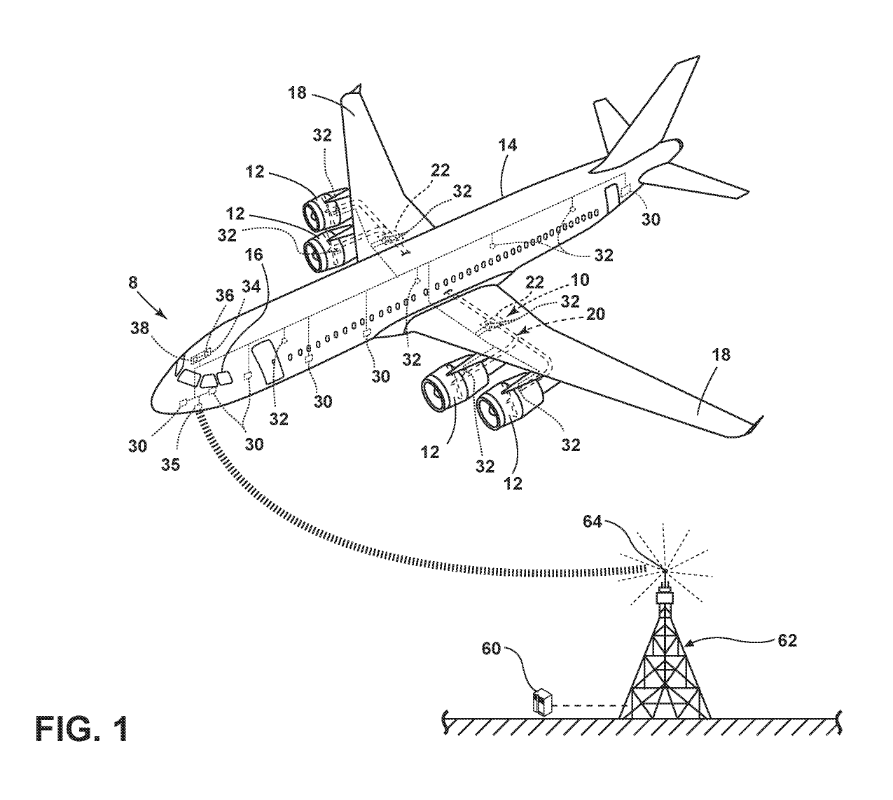

FIG. 1 illustrates an aircraft 8 that may include an air-conditioning system 10, only a portion of which has been illustrated for clarity purposes, and may execute embodiments. As illustrated, the aircraft 8 may include multiple engines 12 coupled to a fuselage 14, a cockpit 16 positioned in the fuselage 14, and wing assemblies 18 extending outward from the fuselage 14. While a commercial aircraft has been illustrated, embodiments may be used in any type of aircraft, for example, without limitation, fixed-wing, rotating-wing, rocket, personal aircraft, and military aircraft. Further, while two engines 12 have been illustrated on each wing assembly 18, it will be understood that any number of engines 12 including a single engine 12 may be included.

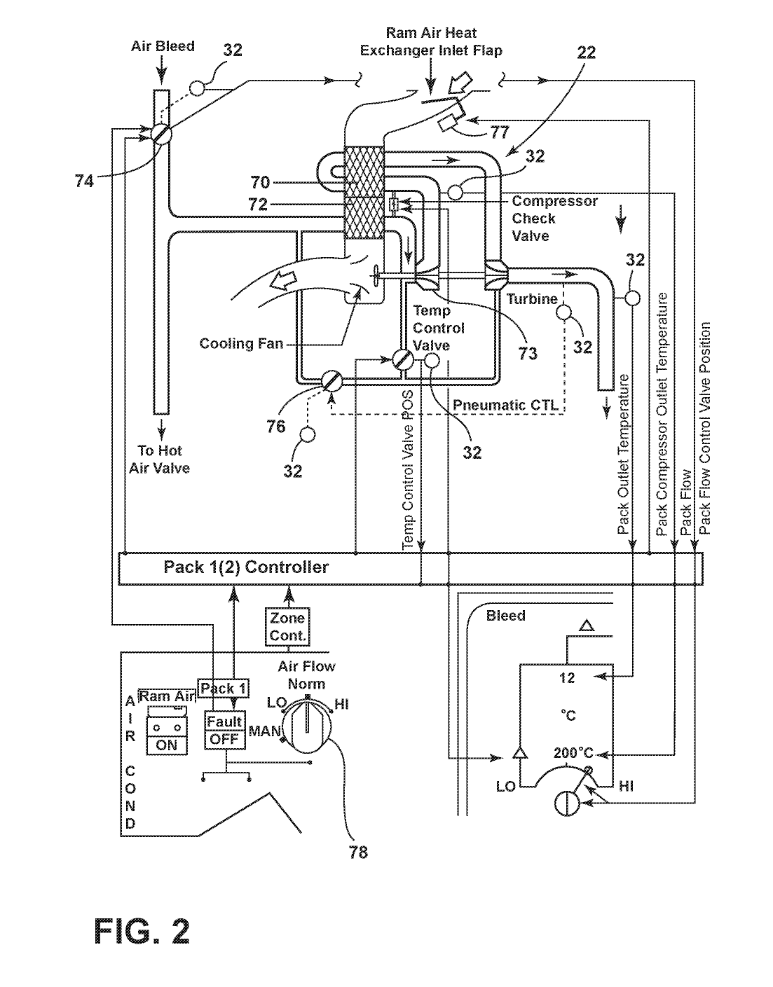

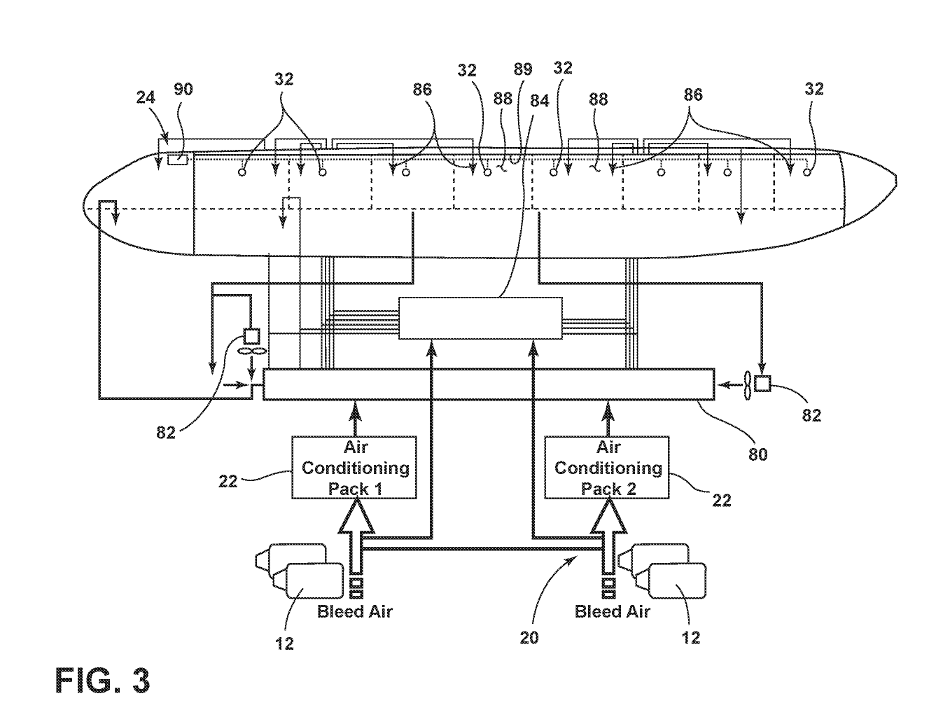

The air-conditioning system 10 may form a portion of the environmental control system of the aircraft 8 and may include a variety of subsystems. For example, among others, a bleed air system 20, one or more air-conditioning packs 22, and an air distribution or cabin temperature control system 24 (FIG. 3) may be included in the air-conditioning system 10. The bleed air system 20 may be connected to each of the engines 12 and air may be supplied to the air-conditioning system 10 by being bled from a compressor stage of each engine 12, upstream of the combustor. Various bleed ports may be connected to various portions of the engine 12 to provide highly compressed air to the bleed air system 20. The temperature and pressure of this bleed air varies widely depending upon which compressor stage and the RPM of the engine 12. The air-conditioning packs 22 and cabin temperature control system 24 will be described in more detail with respect to FIGS. 2 and 3 below.

A plurality of additional aircraft systems 30 that enable proper operation of the aircraft 8 may also be included in the aircraft 8. A number of sensors 32 related to the air-conditioning system 10, its subsystems, and the additional aircraft systems 30 may also be included in the aircraft 8. It will be understood that any number of sensors 32 may be included and that any suitable type of sensors 32 may be included. The sensors 32 may transmit various output signals and information.

A controller 34 and a communication system having a wireless communication link 35 may also be included in the aircraft 8. The controller 34 may be operably coupled to the air-conditioning system 10, the plurality of aircraft systems 30, as well as the sensors 32. The controller 34 may also be connected with other controllers of the aircraft 8. The controller 34 may include memory 36, the memory 36 may include random access memory (RAM), read-only memory (ROM), flash memory, or one or more different types of portable electronic memory, such as discs, DVDs, CD-ROMs, etc., or any suitable combination of these types of memory. The controller 34 may include one or more processors 38, which may be running any suitable programs. The controller 34 may be a portion of an FMS or may be operably coupled to the FMS.

A computer searchable database of information may be stored in the memory 36 and accessible by the processor 38. The processor 38 may run a set of executable instructions to display the database or access the database. Alternatively, the controller 34 may be operably coupled to a database of information. For example, such a database may be stored on an alternative computer or controller. It will be understood that the database may be any suitable database, including a single database having multiple sets of data, multiple discrete databases linked together, or even a simple table of data. In an embodiment, the database may incorporate a number of databases or the database may actually be a number of separate databases. The database may store data that may include historical air-conditioning system data for the aircraft 8 and be related to a fleet of aircraft. The database may also include reference values including threshold values, historic values, or aggregated values and data related to determining such reference values.

Alternatively, in an embodiment, the database may be separate from the controller 34 but may be in communication with the controller 34 such that it may be accessed by the controller 34. For example, in an embodiment, the database may be contained on a portable memory device and in such a case, the aircraft 8 may include a port for receiving the portable memory device and such a port would be in electronic communication with controller 34 such that controller 34 may be able to read the contents of the portable memory device. In an embodiment, the database may be updated through the wireless communication link 35 and in this manner, real time information may be included in the database and may be accessed by the controller 34.

Further, in an embodiment, such a database may be located off the aircraft 8 at a location such as an airline operation center, flight operations department control, or another location. The controller 34 may be operably coupled to a wireless network over which the database information may be provided to the controller 34.

While a commercial aircraft has been illustrated, portions of the embodiments may be implemented anywhere including in a computer or controller 60 at a ground system 62. Furthermore, the database(s) as described above may also be located in a destination server or a controller 60, which may be located at and include the designated ground system 62. Alternatively, the database may be located at an alternative ground location. The ground system 62 may communicate with other devices including the controller 34 and databases located remote from the controller 60 via a wireless communication link 64. The ground system 62 may be any type of communicating ground system 62 such as an airline control or flight operations department.

FIG. 2 illustrates an exemplary schematic view of a cold air unit also known as an air-conditioning pack 22 having a main heat exchanger 70, a primary heat exchanger 72, compressor 73, a flow control valve 74, a turbine 75, an anti-ice valve 76, a ram air inlet flap actuator 77, and a controller 78, which may be located within the cockpit 16 of the aircraft 8 and may be operably coupled to the controller 34. Further, a number of sensors 32 have been illustrated as being included within the air-conditioning pack 22. The sensors 32 may output a variety of data including data related to temperatures of the air-conditioning pack 22, pressures of the air-conditioning pack 22, or valve positions. For example, some of the sensors 32 may output various parameters including binary flags for indicating valve settings and/or positions including, for example, the state of the valve (e.g. fully open, open, in transition, close, fully closed).

It will be understood that any suitable components may be included in the air-conditioning pack 22 such that it may act as a cooling device. The quantity of bleed air flowing to the air-conditioning pack 22 is regulated by the flow control valve 74. The bleed air enters the primary heat exchanger 72 where it is cooled by either ram air, expansion, or a combination of both. The cold air then enters the compressor 73, where it is re-pressurized, which reheats the air. A pass through the main heat exchanger 70 cools the air while maintaining the high pressure. The air then passes through the turbine 75, which expands the air to further reduce heat.

FIG. 3 illustrates an exemplary diagram of a cabin temperature control system 24 having a mixer unit 80, recirculation fans 82, a manifold 84, and nozzles 86 that distribute air into zones 88 within the cabin 89 of the aircraft 8, as well as a control mechanism 90. As illustrated, exhaust air from the air-conditioning packs 22 may be mixed in a mixer unit 80 with filtered air from the recirculation fans 82 and fed into a manifold 84. Air from the manifold 84 may be directed through ducts to overhead distribution nozzles 86 in the various zones 88 of the aircraft 8. A control mechanism 90 may control the temperature in each zone 88 as well as a variety of other aspects of the cabin temperature control system 24. It will be understood that the control mechanism may be operably coupled to the controller 34. A number of sensors 32 may be included and may output signals related to various aspects of the cabin temperature control system 24 including temperatures within the zones 88, pressures within the cabin temperature control system 24, temperatures of physical portions of the cabin temperature control system 24 including duct temperatures, position of trim air valves, a/k/a hot air valves, prior to mixing with the cold pack outlet air, etc.

It will be understood that the controller 34 and the controller 60 merely represent two exemplary embodiments that may be configured to implement embodiments or portions of embodiments. During operation, either the controller 34 and/or the controller 60 may diagnose a fault with the cabin temperature control system 24. By way of non-limiting example, one or more sensors 32 may transmit data relevant to various characteristics of the cabin temperature control system 24. The controller 34 and/or the controller 60 may utilize inputs from the control mechanisms, sensors 32, aircraft systems 30, the database(s), and/or information from airline control or flight operations department to diagnose the fault with the cabin temperature control system 24. Among other things, the controller 34 and/or the controller 60 may analyze the data over time to determine drifts, trends, steps, or spikes in the operation of the cabin temperature control system 24. The controller 34 and/or the controller 60 may also analyze the sensor data and diagnose faults in the cabin temperature control system 24 based thereon. Once a fault with the cabin temperature control system 24 has been diagnosed, an indication may be provided on the aircraft 8 and/or at the ground system 62. In an embodiment, the diagnosis of the fault with the cabin temperature control system 24 may be done during flight, may be done post flight, or may be done after any number of flights. The wireless communication link 35 and the wireless communication link 64 may both be utilized to transmit data such that the fault may be diagnosed by either the controller 34 and/or the controller 60.

One of the controller 34 and the controller 60 may include all or a portion of a computer program having an executable instruction set for diagnosing a cabin temperature control system fault in the aircraft 8. Such diagnosed faults may include improper operation of components as well as failure of components of the cabin temperature control system 24. As used herein the term diagnosing refers to a determination after the fault has occurred and contrasts with prediction, which refers to a forward-looking determination that makes the fault known in advance of when the fault occurs. Along with diagnosing the controller 34 and/or the controller 60 may detect the fault. Regardless of whether the controller 34 and/or the controller 60 runs the program for diagnosing the fault, the program may include a computer program product that may include machine-readable media for carrying or having machine-executable instructions or data structures stored thereon.

It will be understood that details of environments that may implement embodiments are set forth in order to provide a thorough understanding of the technology described herein. It will be evident to one skilled in the art, however, that the exemplary embodiments may be practiced without these specific details. The exemplary embodiments are described with reference to the drawings. These drawings illustrate certain details of specific embodiments that implement a module or method, or computer program product described herein. However, the drawings should not be construed as imposing any limitations that may be present in the drawings. The method and computer program product may be provided on any machine-readable media for accomplishing their operations. The embodiments may be implemented using an existing computer processor, or by a special purpose computer processor incorporated for this or another purpose, or by a hardwired system. Further, multiple computers or processors may be utilized including that the controller 34 and/or the controller 60 may be formed from multiple controllers. It will be understood that the controller diagnosing the fault may be any suitable controller including that the controller may include multiple controllers that communicate with each other.

As noted above, embodiments described herein may include a computer program product including machine-readable media for carrying or having machine-executable instructions or data structures stored thereon. Such machine-readable media may be any available media, which may be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium that can be used to carry or store desired program codes in the form of machine-executable instructions or data structures and that can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data, which cause a general-purpose computer, special purpose computer, or special purpose processing machines to perform a certain function or group of functions.

Embodiments will be described in the general context of method steps that may be implemented in one embodiment by a program product including machine-executable instructions, such as program codes for example, in the form of program modules executed by machines in networked environments. Generally, program modules include routines, programs, objects, components, data structures, etc. that have the technical effect of performing particular tasks or implement particular abstract data types. Machine-executable instructions, associated data structures, and program modules represent examples of program codes for executing steps of the method disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the internet and may use a wide variety of different communication protocols. Those skilled in the art will appreciate that such network computing environments will typically encompass many types of computer system configurations, including personal computers, hand-held devices, multiprocessor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination of hardwired or wireless links) through a communication network. In a distributed computing environment, program modules may be located in both local and remote memory storage devices.

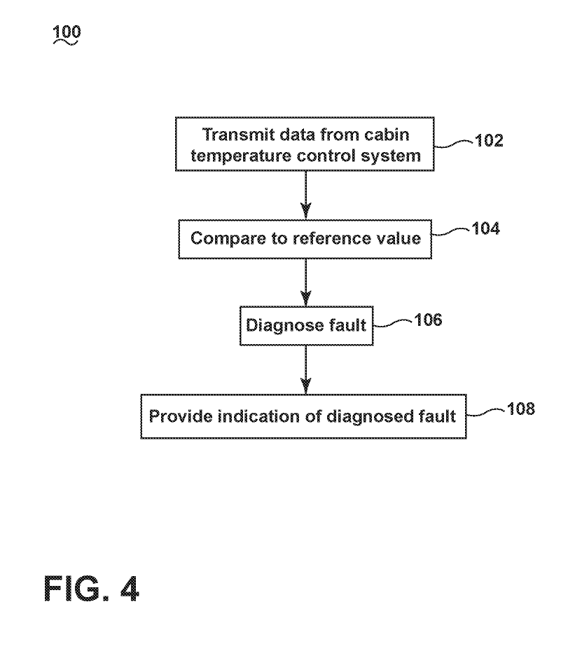

In accordance with an embodiment, FIG. 4 illustrates a method 100, which may be used for diagnosing a fault in the cabin temperature control system 24; such a diagnosed fault may include a diagnosed failure. The method 100 begins at 102 by transmitting from one or more sensors 32 data related to the air conditioning system 10 including the cabin temperature control system 24. More specifically, multiple temperature sensor readings may be transmitted from temperature sensors 32 coupled to the air conditioning system 10. This may include sequentially and/or simultaneously transmitting data from the sensors 32. The transmitted data may be received by any suitable device including a database or the controller 34 and/or the controller 60.

In an embodiment, the senor output may include raw data from which a variety of other information may be derived or otherwise extracted to define the sensor output. It will be understood that regardless of whether the sensor output is received directly or derived from received output, the output may be considered to be sensor output. For example, the sensor output may be aggregated over time to define aggregated sensor data. Aggregating the received sensor output over time may include aggregating the received sensor output over multiple phases of flight and/or over multiple flights. Such aggregated sensor data may be reset after a maintenance event. For example, the fault may be based on derived data such as medians, minima, maximum values, standard deviations, counts above or below thresholds, change of state, correlations, etc. that may be calculated per phases of the flight of the aircraft or over multiple phases of flight. For example, in an embodiment, the multiple temperature sensor readings may be transmitted over time during a phase of flight. For example, multiple temperature sensor readings may be transmitted during pre-flight, cruise, or post-flight. In such an instance, a median, maximum, minimum, standard deviation of the multiple temperature sensor readings transmitted during the phase of flight may be determined from the multiple temperature sensor readings. In an embodiment, the multiple temperature sensor readings may be transmitted during multiple phases of flight. In that instance, a median, maximum, minimum, standard deviation of the multiple temperature sensor readings transmitted may be determined for each of the multiple phases of flight or over the multiple phases of flight.

At 104, the transmitted multiple temperature sensor readings may be compared to reference values related to the multiple temperature sensor readings. The reference values may be any suitable reference values related to the sensor output including predetermined thresholds, historical reference values, etc. Furthermore, the reference values may include values that have been determined during flight such as one of the multiple temperature sensor readings. In this manner, it will be understood that the reference value for the transmitted reading(s) may be defined during operation. For example, the reference value could be a temperature determined from an alternative portion of the aircraft. Alternatively, the reference values may be stored in one of the database(s) as described above.

In this manner, temperature sensor readings may be compared to reference values and any suitable comparison may be made. For example, the comparison may include determining a difference between the sensor output and the reference value. By way of non-limiting example, the comparison may include comparing a recent signal output to a historic value. The comparison may include determining a measure of maximum temperature above a given threshold. The comparison may alternatively include determining a pressure difference between engines on the same aircraft 8. Comparisons may be made on a per flight basis or the data may be processed per individual engine over a series of flights. In an embodiment, comparisons may be limited to being within various indicated fan speed ranges due to dependency of temperature variation on the indicated fan speed. Comparisons may further measure a change in correlation between two parameters including where the correlation exceeds a given threshold.

At 106, a fault in the cabin temperature control system 24 may be diagnosed based on the comparisons at 104. For example, a fault in the cabin temperature control system 24 may be diagnosed when the comparison indicates that the sensor satisfies a predetermined threshold. The term “satisfies” the threshold is used herein to mean that the variation comparison satisfies the predetermined threshold, such as being equal to, less than, or greater than the threshold value. It will be understood that such a determination may easily be altered to be satisfied by a positive/negative comparison or a true/false comparison. For example, a less than threshold value can easily be satisfied by applying a greater than test when the data is numerically inverted.

Any number of faults in the cabin temperature control system 24 may be determined. By way of non-limiting example, a fault may be diagnosed with a cabin air temperature sensor. For example, the detection and diagnosis of a fault with an air temperature sensor 32 may rely on features generated from that particular sensor 32 including by way of non-limiting examples median, maximum, minimum, and standard deviation during cruise. Features calculated for different phases of flight including pre-flight, cruise, and post-flight may be used together to ascertain that the apparent error in the recorded value is real and not a transient anomaly. Calculating features for different phases allows comparisons to be made within a stable and consistent range. This reduces the variability of the comparisons and makes diagnosing faults in the comparisons more reliable and easier to detect. In addition, the behavior may be different for different phases and aids diagnosis when comparisons are made on and between different phases. For example, on the ground the air conditioning is trying to cool the cabin, particularly in hot climates, whilst at cruise altitude the air conditioning is trying to heat the cabin. Such different behaviors mean the system operates differently in different phases and will result in different diagnosis of faults. It will be understood that any number of faults may be diagnosed based on any number of comparisons. These comparisons may also be used to provide information relating to the severity of the fault.

By way of further example, in an embodiment, the multiple temperature sensor readings transmitted at 102 may include at least one air temperature within a zone 88 and a duct temperature feeding the zone 88. In such an instance, by way of non-limiting example, diagnosing the fault at 106 may include diagnosing a fault of the air temperature sensor 32 for the zone 88 when the multiple comparisons indicate the transmitted air temperature measurement is out of bounds and the transmitted duct temperature is within bounds. Alternatively, the multiple temperature sensor readings transmitted at 102 may include air temperature readings from multiple zones 88. In such an instance, diagnosing the fault at 106 may include diagnosing a fault of one of the temperature sensors 32 when the comparisons indicate a transmitted air temperature measurement in one of the zones 88 is out of bounds. It is further possible that for the fault of the temperature sensor 32 to be diagnosed that the comparisons at 104 must also indicate that an air temperature measurement in an adjacent zone 88 is in bounds. Thus, it will be understood that the diagnosis of the fault with the air temperature sensor 32 may also be determined based on other related measurements from adjacent zones, a temperature of a duct temperature feeding that zone, a set temperature for the zone, etc. Alternatively, diagnosing a sensor fault may be based on the behavior of the sensor alone, with comparison to a reference value such as other sensors. Unrealistic variation or absolute values from the sensor is sufficient to indicate a fault in the sensor. With respect to a cabin temperature sensor, a temperature of less than 0 degrees C. or greater than 50 degrees C. are unrealistic within the cabin during normal operation and would indicate a fault.

In implementation, the reference values for the sensor output and comparisons may be converted to an algorithm to diagnose faults in the cabin temperature control system 24. Such an algorithm may be converted to a computer program including a set of executable instructions, which may be executed by the controller 34 and/or the controller 60. Various other parameters recorded by onboard systems such as altitude, valve settings, etc. may also be utilized by such a computer program to diagnose faults in the cabin temperature control system 24. Alternatively, the computer program may include a model, which may be used to diagnose faults in the cabin temperature control system 24 of the air-conditioning system 10. A model may include the use of reasoning networks, flow charts, or decision trees. The model may be implemented in software as an algorithm, such as one or more mathematical algorithms. Diagnosis may be based upon understanding of the system and patterns in the data compared to previous faults. The model may ensure all information available is used and may discount false positives. Faults in the duct (in particular duct attachment) can be diagnosed from comparisons with the duct and\or cabin compartment temperature and the pack output temperature. Leaks and\or disattachment in the duct will result in the duct temperature remaining high whilst the pack attempts to cool the duct by further lowering the pack output temperature.

At 108, the controller 34 and/or the controller 60 may provide an indication of the fault in the cabin temperature control system 24 diagnosed at 106. The indication may be provided in any suitable manner at any suitable location including in the cockpit 16 and at the ground system 62. For example, the indication may be provided on a primary flight display (PFD) in a cockpit 16 of the aircraft 8. If the controller 34 ran the program, then the suitable indication may be provided on the aircraft 8 and/or may be uploaded to the ground system 62. Alternatively, if the controller 60 ran the program, then the indication may be uploaded or otherwise relayed to the aircraft 8. Alternatively, the indication may be relayed such that it may be provided at another location such as an airline control or flight operations department.

It will be understood that the method of diagnosing a cabin temperature control system 24 fault is flexible and the method illustrated is merely for illustrative purposes. For example, the sequence of steps depicted is for illustrative purposes only, and is not meant to limit the method 100 in any way, as it is understood that the steps may proceed in a different logical order or additional or intervening steps may be included without detracting from embodiments. Further still, comparing the transmitted data to a reference value may include determining a difference between related temperatures in the air-conditioning system 10 and then comparing that difference to a reference difference value. For example, deltas between adjacent and/or related temperatures may be used to highlight anomalous temperature measurements. The deltas allow normalization of the cabin compartment temperatures since, it is assumed, actual cabin temperatures across the different compartments will not vary significantly at any one time. This will reduce the effect of the variability observed in cabin compartment temperatures in normal operation, for example, the variability observed in certain phases, for example, pre-flight, due to seasonal variations. Any significant variation of one compartment temperature with another can diagnose a fault in that sensor\system

Potentially beneficial effects of the above-described embodiments include that data gathered by the aircraft may be utilized to diagnose a cabin temperature control system fault. This reduces maintenance times and the operational impact of faults and issues due to the cabin temperature control system. Particularly there may be a reduction in the time required to diagnose an issue and issues may be diagnosed accurately. This allows for cost savings by reducing maintenance cost, rescheduling cost, and minimizing operational impacts including minimizing the time aircraft are grounded.

This written description uses examples to disclose the embodiments, including the best mode, and also to enable any person skilled in the art to practice the embodiments, including making and using any devices or systems and performing any incorporated methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of diagnosing a fault in a cabin temperature control system of an air-conditioning system of an aircraft, the method comprising:
transmitting multiple temperature sensor readings from temperature sensors, wherein the temperature sensors are operably coupled to the air-conditioning system;
comparing the transmitted multiple temperature sensor readings to related reference values;
diagnosing, by a controller, a fault in the cabin temperature control system based on the comparing; and
providing an indication of the diagnosed fault.

2. The method of claim 1, wherein the multiple temperature sensor readings are transmitted during a phase of flight.

3. The method of claim 2, further comprising calculating one of a median, maximum, minimum, or standard deviation of the multiple temperature sensor readings transmitted during the phase of flight.

4. The method of claim 2, wherein transmitting the multiple temperature sensor readings comprises transmitting multiple temperature sensor readings during a pre-flight, a cruise, or a post-flight.

5. The method of claim 2, wherein transmitting the multiple temperature sensor readings comprises transmitting multiple temperature sensor readings during multiple phases of flight.

6. The method of claim 5, further comprising calculating one of a median, maximum, minimum, or standard deviation of the multiple temperature sensor readings transmitted for each of the multiple phases of flight where data is transmitted.

7. The method of claim 1, wherein the controller utilizes an algorithm to diagnose the fault.

8. The method of claim 1, wherein the aircraft has multiple zones within a cabin of the aircraft.

9. The method of claim 8, wherein the multiple temperature sensor readings of the air-conditioning system comprise at least one air temperature sensor reading from within at least one of the multiple zones, wherein a duct temperature is feeding the at least one of the multiple zones.

10. The method of claim 9, wherein diagnosing the fault comprises diagnosing a fault of an air temperature sensor when the comparing indicates an air temperature measurement is out of bounds and the duct temperature is within bounds.

11. The method of claim 8, wherein the multiple temperature sensor readings comprise air temperature readings from multiple zones.

12. The method of claim 11, wherein diagnosing the fault comprises diagnosing the fault of one of the temperature sensors when the comparing indicates an air temperature measurement in one of the zones is out of bounds.

13. The method of claim 12, wherein the fault is diagnosed with the one of the temperature sensors when the comparing indicates an air temperature measurement in an adjacent zone is in bounds.

14. The method of claim 1, wherein comparing the transmitted data to a reference value comprises determining a difference between related temperatures in the air-conditioning system and comparing the difference to a reference difference value.

15. The method of claim 3, wherein transmitting the multiple temperature sensor readings comprises transmitting multiple temperature sensor readings during a pre-flight, a cruise, or a post-flight.

16. The method claim 3, wherein transmitting the multiple temperature sensor readings comprises transmitting multiple temperature sensor readings during multiple phases of flight.

17. The method claim 4, wherein transmitting the multiple temperature sensor readings comprises transmitting multiple temperature sensor readings during multiple phases of flight.

18. The method of claim 9, wherein the multiple temperature sensor readings comprise air temperature readings from multiple zones.

19. The method of claim 10, wherein the multiple temperature sensor readings comprise air temperature readings from multiple zones.
